(19) United States
(12) Patent Application Publication
(10) Pub. No.: US 2021/0079212 A1
(43) Pub. Date: Mar. 18, 2021

(54) ECO-FRIENDLY POLYESTER MOLDING COMPOSITION AND METHOD FOR MANUFACTURING PLASTIC BOARD

(71) Applicant: NAN YA PLASTICS CORPORATION, Taipei (TW)

(72) Inventors: TE-CHAO LIAO, TAIPEI (TW); JUNG-JEN CHUANG, TAIPEI (TW); CHUNG-YU CHEN, TAIPEI (TW); SUNG-CHIEH CHAO, TAIPEI (TW)

(21) Appl. No.: 16/865,115

(22) Filed: May 1, 2020

(30) Foreign Application Priority Data
Sep. 16, 2019 (TW) 108133172

(51) Int. Cl. C08L 67/07; C08J 5/04

(52) U.S. Cl. CPC C08L 67/07; C08K 7/14; C08J 5/043

(57) ABSTRACT

An eco-friendly polyester molding composition and a method for manufacturing a plastic board are provided. The eco-friendly polyester molding composition includes 50 to 100 PHR of unsaturated polyester resin, 50 to 250 PHR of a filler, 50 to 200 PHR of glass fiber and 0.5 to 10 PHR of at least two initiators. The at least two initiators include a high temperature initiator and a low-to-medium temperature initiator which are mixed in a mass ratio of 0.5-4:1.

### CROSS-REFERENCE TO RELATED PATENT APPLICATION

This application claims the benefit of priority to Taiwan Patent Application No. 108133172, filed on Sep. 16, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a molding composition, and more particularly to an eco-friendly polyester molding composition and a method for manufacturing a plastic board that uses the eco-friendly polyester molding composition.

### BACKGROUND OF THE DISCLOSURE

In a time when forest resources have depleted and many countries have prohibited people from logging and prohibited the export of logs for environmental protection, prices of wooden products (e.g., wooden furniture) have increased. Simulated wood products do not easily rot, and have no peculiar smells of rotted wood caused by weathering and no problems caused by wood borers, such that they have been used in place of wooden products. The simulated wood products, as the name implies, are plastic products having a texture, an appearance and mechanical properties which are similar to those of the wooden products, common applications of which include building materials, decorative materials and furniture.

In the related art, the completed sheet molding compound (SMC) is used to manufacture the simulated wood products, in which styrene serving as a crosslinking agent is usually required to be added to an unsaturated resin system to initiate a free radical chain reaction during the molding process. However, impurities in the air will combine with free radicals to stop the chain reaction and thus styrene is difficult to be completely reacted. In addition, residual styrene in the plastic products may easily be emitted to the atmosphere and cause harm to human health.

In order to reduce the emission of styrene, common methods include adding a surface film forming agent and using a crosslinking agent having high boiling point in place of styrene. However, styrene, compared to unsaturated resin systems, has better applicability. Furthermore, the addition of the surface film forming agent causes an increase in manufacturing costs, which negatively impacts commercial viability.

### SUMMARY OF THE DISCLOSURE

In response to the above-referenced technical inadequacies, the present disclosure provides an eco-friendly polyester molding composition and a method for manufacturing a plastic board that uses the eco-friendly polyester molding composition.

In one aspect, the present disclosure provides an eco-friendly polyester molding composition which includes 50 to 100 PHR of unsaturated polyester resin, 50 to 250 PHR of a filler, 50 to 200 PHR of glass fiber and 0.5 to 10 PHR of at least two initiators. The at least two initiators include a high temperature initiator and a low-to-medium temperature initiator which are mixed in a mass ratio of 0.5-4:1. The high temperature initiator is selected from at least one of dicumyl peroxide, tert-butyl peroxybenzoate, tert-amyl peroxybenzoate and 2,5-dimethyl-2,5-di-(tert-butylperoxy)hexane. The low-to-medium temperature initiator is selected from at least one of dibenzoyl peroxide and 1,1-bis(tert-butylperoxy)-3,3,5-trimethylcyclohexane.

In certain embodiments, the mass ratio of the high temperature initiator to the low-to-medium temperature initiator is 1.6:1.

In certain embodiments, the high temperature initiator is tert-butyl peroxybenzoate, and the low-to-medium temperature initiator is 1,1-bis(tert-butylperoxy)-3,3,5-trimethylcyclohexane.

In certain embodiments, the unsaturated polyester resin has a structure represented by the following formula: S-G-U-G-S-G-U-G-U-G-S; S representing a saturated acid; G representing a diol; U representing an unsaturated acid.

In certain embodiments, the unsaturated polyester resin has a molecular weight between 3,000 and 15,000.

In certain embodiments, the filler is an inorganic filler that is selected from at least one of talc powder, mica powder, calcium silicate, calcium carbonate, barium sulfate, alumina (Al₂O₃) and glass fiber.

In certain embodiments, the glass fiber has a length between 0.5 cm and 5 cm.

In certain embodiments, the eco-friendly polyester molding composition further includes 20 to 70 PHR of an additive that is selected from at least one of a polymerization inhibitor, a low shrinkage agent, a tackifier, a mold release agent and a colorant.

In another aspect, the present disclosure provides a method for manufacturing a plastic board which includes: well mixing the eco-friendly polyester molding composition as mentioned above to form a fiber-reinforced resin material; and molding the fiber-reinforced resin material into the plastic board at a molding temperature between 130° C. and 150° C.; the plastic board having a styrene emission rate of 45 μg/m²×hr.

In certain embodiments, the method further includes trimming the plastic board and applying a coating to the plastic board.

One of the advantages of the present disclosure is that the eco-friendly polyester molding composition can effectively reduce an emission rate of a contained volatile organic compound by the technical features of “the at least two initiators includes a high temperature initiator and a low-to-medium temperature initiator which are mixed in a mass ratio of 0.5-4:1, the high temperature initiator is selected from at least one of dicumyl peroxide, tert-butyl peroxybenzoate, tert-amyl peroxybenzoate and 2,5-dimethyl-2,5-di-(tert-butylperoxy)hexane, and the low-to-medium temperature initiator is selected from at least one of dibenzoyl peroxide and 1,1-bis(tert-butylperoxy)-3,3,5-trimethylcyclohexane.” In particular, the emission rate of styrene is in compliance with the standard stipulated by California Act No. 65, i.e., is less than 27 μg/day.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a block diagram illustrating a continuous-type production apparatus for manufacturing a plastic board using an eco-friendly polyester molding composition of the present disclosure.

FIG. 2 is a schematic view showing a manufacturing process of the plastic board based on the eco-friendly polyester molding composition of the present disclosure.

FIG. 3 is a schematic view showing the structure of the plastic board based on the eco-friendly polyester molding composition of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

SMC imitation wood products (e.g., an imitation wood door), after being coating-treated, can have a wood-like texture and appearance, which can be used in place of wooden products so as to save forest resources. Therefore, the present disclosure provides an eco-friendly polyester molding composition that can serve as an SMC material. The resulting imitation wood product can effectively reduce an emission rate of a contained volatile organic compound. In particular, the emission rate of styrene complies with the standard stipulated by California Act No. 65, i.e., is less than 27 μg/day. The eco-friendly polyester molding composition of the present disclosure mainly includes 50 to 100 PHR of unsaturated polyester resin, 50 to 250 PHR of a filler, 50 to 200 PHR of glass fiber and 0.5 to 10 PHR of at least two initiators.

More specifically, the unsaturated polyester resin serving as a basic ingredient may be obtained from the polymerization of saturated and unsaturated acids and diol(s). Examples of the saturated acid include ortho-phthalic anhydride, isophthalic acid, terephthalic acid and adipic acid. Examples of the unsaturated acid include maleic anhydride and fumaric acid. Examples of the diol include propylene glycol, dipropylene glycol, ethylene glycol, diethylene glycol, neopentyl glycol and bisphenol A.

In the present embodiment, the content of the unsaturated polyester resin may be 60 PHR, 70 PHR, 80 PHR or 90 PHR. The unsaturated polyester resin has a structure represented by the following formula: S-G-U-G-S-G-U-G-U-G-S; S represents a saturated acid; G represents a diol; U represents an unsaturated acid. The unsaturated polyester resin has a molecular weight between 3,000 and 15,000. In use, methyl methacrylate or styrene monomer can be added to the unsaturated polyester resin, which can serve as a solvent and also as a crosslinking agent, such that the unsaturated polyester resin can be formed into a three-dimensional thermosetting material.

The filler can be added to increase the structural strength of a plastic molding product and reduce costs. The filler is an inorganic filler that is selected from at least one of talc powder, mica powder, calcium silicate, calcium carbonate, barium sulfate, alumina (Al₂O₃) and glass fiber. In consideration of the moisture resistance of the plastic molding product, the filler can be calcium carbonate. In the present embodiment, the filler is present in the form of particles, the average particle diameter of which is between 1 μm and 10 μm. The content of the filler may be 60 PHR, 70 PHR, 80 PHR, 90 PHR, 100 PHR, 110 PHR, 120 PHR, 130 PHR, 140 PHR, 150 PHR, 160 PHR, 170 PHR, 180 PHR, 190 PHR, 200 PHR, 210 PHR, 220 PHR, 230 PHR or 240 PHR.

The glass fiber can be added to improve the mechanical properties of the plastic molding product, and also to provide properties required for the plastic molding product such as chemical resistance, heat resistance, moisture resistance, good heat and sound insulation effects and good electrical insulation. In the present embodiment, the size of the glass fiber is between 0.5 μm and 5 μm. The content of the glass fiber may be 60 PHR, 70 PHR, 80 PHR, 90 PHR, 100 PHR, 110 PHR, 120 PHR, 130 PHR, 140 PHR, 150 PHR, 160 PHR, 170 PHR, 180 PHR, 190 PHR or 200 PHR.

The at least two initiators can be added to increase the crosslinking rate, such that the eco-friendly polyester molding composition of the present disclosure can be quickly formed. It should be noted that, the at least two initiators includes a high temperature initiator and a low-to-medium temperature initiator which are mixed in a mass ratio of 0.5-4:1, and preferably in the mass ratio of 1.6:1. The high temperature initiator is selected from at least one of dicumyl peroxide, tert-butyl peroxybenzoate, tert-amyl peroxybenzoate and 2,5-dimethyl-2,5-di-(tert-butylperoxy)hexane. The low-to-medium temperature initiator is selected from at least one of dibenzoyl peroxide and 1,1-bis(tert-butylperoxy)-3,3,5-trimethylcyclohexane. Therefore, the emission rate of a volatile organic compound contained in the plastic molding product can be effectively reduced. In particular, the emission rate of styrene is 45 μg/m²×hr, which meets the environmental protection requirements of the U.S. and EU regulations. In a certain embodiment, the mass ratio of the high temperature initiator to the low-to-medium temperature initiator is 2:1 or 2.5:1.

If necessary, the eco-friendly polyester molding composition of the present disclosure may include 20 to 70 PHR of an additive that is selected from at least one of a polymerization inhibitor, a low shrinkage agent, a tackifier, a mold release agent and a colorant. More specifically, the polymerization inhibitor may prevent the unsaturated polyester from pre-crosslinking, and the content thereof may be 0 to 5 PHR. The low shrinkage agent may prevent the molding composition from shrink-deforming during the molding process, and the content thereof may be 10 to 50 PHR. The low shrinkage agent may be a thermoplastic such as acrylic, polyethylene or polystyrene. The tackifier may allow the molding composition to have a desired viscosity that is suitable for being processed (e.g., molded), and the content thereof may be 1 to 10 PHR. The tackifier may be a metal oxide or metal hydroxide such as magnesium oxide, calcium oxide, magnesium hydroxide or calcium hydroxide. The mold release agent may allow the plastic molding product to be easily and completely released from a mold easily, and the content thereof may be 1 to 10 PHR. The mold release agent may be a stearate such as calcium stearate or zinc stearate. The colorant may allow the plastic molding product to have a desired color. The colorant may be an organic or inorganic colorant, specific examples of which include titanium dioxide, zinc oxide, carbon black, cadmium yellow, chrome yellow, titanium yellow, benzidine yellow G, benzidine yellow 10G and cadmium red. However, these technical details are only feasible implementations of the present embodiment, and should not be construed as limiting the scope of the present disclosure.

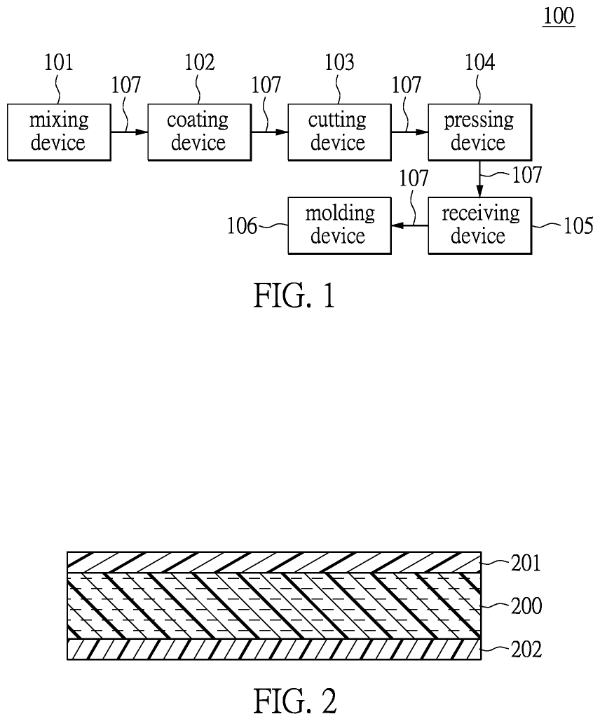

Referring to FIG. 1 to FIG. 3, the eco-friendly polyester molding composition of the present disclosure can be formed into a plastic board 200′ by a continuous-type production apparatus 100. The continuous-type production apparatus 100 mainly includes a mixing device 101, a coating device 102, a cutting device 103, a pressing device 104, a receiving device 105 and a molding device 106, and a workpiece can be transferred between these devices by a transfer device 107.

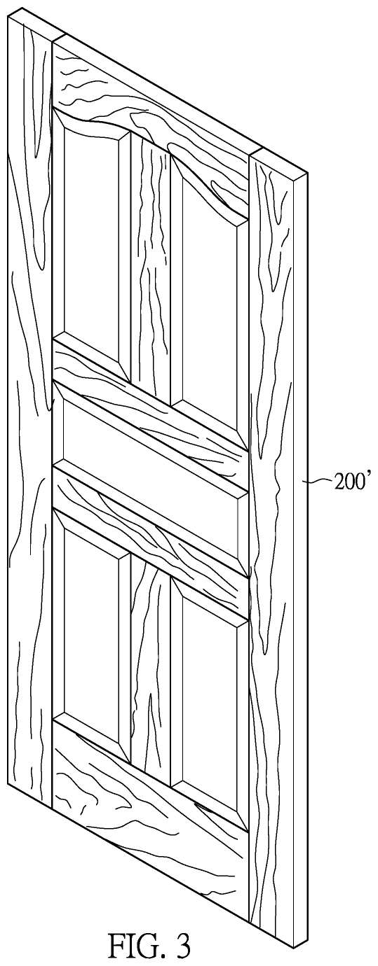

More specifically, the ingredients of the molding composition, except for the glass fiber, can be well-mixed in predetermined amounts by the mixing device 101, and the obtained mixture can be coated on a carrying film such as a nylon film or polyethylene film by the coating device 102. In the present embodiment, an upper carrying film 201 and a lower carrying film 202 are used to respectively carry a portion of the mixture, as shown in FIG. 2. The glass fiber can be cut into a desired size by the cutting device 103, so as to be uniformly provided to the mixture in a suitable manner (e.g., spreading). After that, the upper carrying film 201 and the lower carrying film 202 together with the mixture and the glass fiber can be transferred to the pressing device 104. Accordingly, the glass fiber can be completely dipped into the mixture at a suitable pressure (e.g., 20 psi) to form a fiber-reinforced resin material 200 having a thickness of about 1.5-2.5 mm. The fiber-reinforced resin material 200 can be received at a predetermined rate (e.g., 4-20 M/min) and wound into a roll by the receiving device 105. Also, the fiber-reinforced resin material 200 can be placed in a storage tank (not shown). Finally, the fiber-reinforced resin material 200 can be molded into a plastic board 200′.

It should be noted that, in the circumstance that the fiber-reinforced resin material 200 is molded by the molding device 106 in the presence of the predetermined high temperature and low-to-medium temperature initiators, the molding temperature must be controlled at from 130° C. to 150° C. Furthermore, post processes such as trimming, coating and assembling process can be performed on the plastic board 200′ according to particular requirements, so as to form an imitation wood product. When an imitation wood door is taken for an example, the plastic board 200′ can be combined with one or more wood strips or plastic foam materials, and be filled with one or more PU foams to have a thicker look. In addition, a mold may be provided with a simulated wood grain texture to allow the molded plastic board 200′ to have a realistic wood grain texture and a distinct contrast between deep and light colors after coating.

Based on the above, the present disclosure further provides a method for manufacturing the plastic board. The method includes: well mixing the eco-friendly polyester molding composition as mentioned above to form a fiber-reinforced resin material; and molding the fiber-reinforced resin material into the plastic board at a molding temperature between 130° C. and 150° C. It should be noted that the plastic board has a styrene emission rate of 45 μg/m²×hr as shown in test results.

### Example 1

The eco-friendly polyester molding composition includes 60 PHR of an unsaturated polyester resin, 150 PHR of calcium carbonate serving as a filler, 60 PHR of glass fiber, 0.5 to 10 PHR of at least two initiators and 60 PHR of an additive. In Example 1, the high temperature initiator is tert-butyl peroxybenzoate and the low-to-medium temperature initiator is 1,1-bis(tert-butylperoxy)-3,3,5-trimethylcyclohexane, which are mixed in the mass ratio of 2:1. The emission rate of styrene is 1320 μg/m²×hr, which is detected by gas chromatograph with mass spectrometry according to the ASTM D5116 standard. It is estimated that the lifetime average daily dose (LADD) of styrene is 700-800 μg/day. The additive may be selected from at least one of a polymerization inhibitor, a low shrinkage agent, a tackifier, a mold release agent and a colorant.

### Example 2

Example 2 uses the same ingredients and amounts as Example 1. The differences from Example 1 are as follows. The high temperature initiator is tert-butyl peroxybenzoate and the low-to-medium temperature initiator is 1,1-bis(tert-butylperoxy)-3,3,5-trimethylcyclohexane, which are mixed in the mass ratio of 2.5:1. The molding temperature is between 135° C. and 145° C. The emission rate of styrene is 228 μg/m²×hr, which is detected by gas chromatograph with mass spectrometry according to the ASTM D5116 standard. It is estimated that the LADD of styrene is 134.1 μg/day.

### Example 3

The same ingredients and amounts are used as in Example 1. The differences from Example 1 are as follows. The high temperature initiator is tert-butyl peroxybenzoate and the low-to-medium temperature initiator is 1,1-bis(tert-butylperoxy)-3,3,5-trimethylcyclohexane, which are mixed in the mass ratio of 1.6:1. The molding temperature is between 137° C. and 145° C. The emission rate of styrene is 30 μg/m²×hr, which is detected by gas chromatograph with mass spectrometry according to the ASTM D5116 standard. It is estimated that the LADD of styrene is 15-25 μg/day.

### Example 4

The same ingredients and amounts are used as in Example 1. The differences from Example 1 are as follows. The high temperature initiator is tert-butyl peroxybenzoate and the low-to-medium temperature initiator is 1,1-bis(tert-butylperoxy)-3,3,5-trimethylcyclohexane, which are mixed in the mass ratio of 1.6:1. The molding temperature is between 137° C. and 145° C., and the molding time increases by 30%. The emission rate of styrene is 12 μg/m²×hr, which is detected by gas chromatograph with mass spectrometry according to the ASTM D5116 standard. It is estimated that the LADD of styrene is 10-15 μg/day.

One of the advantages of the present disclosure is that the eco-friendly polyester molding composition can effectively reduce an emission rate of a contained volatile organic compound by the technical features of “the at least two initiators includes a high temperature initiator and a low-to-medium temperature initiator which are mixed in a mass ratio of 0.5-4:1, the high temperature initiator is selected from at least one of dicumyl peroxide, tert-butyl peroxybenzoate, tert-amyl peroxybenzoate and 2,5-dimethyl-2,5-di-(tert-butylperoxy)hexane, and the low-to-medium temperature initiator is selected from at least one of dibenzoyl peroxide and 1,1-bis(tert-butylperoxy)-3,3,5-trimethylcyclohexane.” In particular, the emission rate of styrene is in compliance with the standard required for California Act No. 65, i.e., is less than 27 μg/day.

Furthermore, the method of the present disclosure for manufacturing the plastic board, which is used to mold the eco-friendly polyester molding composition that can serve as an SMC material, is different from the manual lamination method that is commonly used for fiber-reinforced plastic materials. The differences between the above methods are shown in Table 1. Furthermore, the plastic board obtained by using the eco-friendly polyester molding composition has a texture, an appearance and mechanical properties (e.g., high mechanical strength and low deformation rate) which are similar to those of a wooden product. In addition, the resulting wastes can be recycled and reused, which complies with environmental protection and economic benefits.

TABLE 1

| | Manual lamination method | SMC molding method | |
|---|---|---|---|
| Mold of use | Wood, resin or plaster | Metal mold | |
| | mold | | |
| Molding | 20-50° C. | 130-150° | C. |
| temperature | | | |
| Molding | 0 | 30-200 | Kg/cm² |
| pressure | | | |

| | | |
|---|---|---|
| Molding | From 30 minutes to 24 hours | From 1 to 10 minutes |
| cycle period | | |
| Features | Slow production speed, manual | Quick production speed, |
| | process, human factors have a | product having a thinner |
| | greater influence on product | and uniform thickness, |
| | quality, and only one side of | uniform distribution of |
| | product is laminated. | glass fiber, and stable |
| | | product quality. |

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An eco-friendly polyester molding composition, comprising:
50 to 100 PHR of an unsaturated polyester resin;
50 to 250 PHR of a filler;
50 to 200 PHR of glass fiber; and
0.5 to 10 PHR of at least two initiators including a high temperature initiator and a low-to-medium temperature initiator which are mixed in a mass ratio of 0.5-4:1, wherein the high temperature initiator is selected from at least one of dicumyl peroxide, tert-butyl peroxybenzoate, tert-amyl peroxybenzoate and 2,5-dimethyl-2,5-di-(tert-butylperoxy)hexane, and the low-to-medium temperature initiator is selected from at least one of dibenzoyl peroxide and 1,1-bis(tert-butylperoxy)-3,3,5-trimethylcyclohexane.

2. The eco-friendly polyester molding composition according to claim 1, wherein the mass ratio of the high temperature initiator to the low-to-medium temperature initiator is 1.6:1.

3. The eco-friendly polyester molding composition according to claim 2, wherein the high temperature initiator is tert-butyl peroxybenzoate, and the low-to-medium temperature initiator is 1,1-bis(tert-butylperoxy)-3,3,5-trimethylcyclohexane.

4. The eco-friendly polyester molding composition according to claim 1, wherein the unsaturated polyester resin has a structure represented by the following formula: S-G-U-G-S-G-U-G-U-G-S; S representing a saturated acid, G representing a diol, and U representing an unsaturated acid.

5. The eco-friendly polyester molding composition according to claim 4, wherein the unsaturated polyester resin has a molecular weight between 3,000 and 15,000.

6. The eco-friendly polyester molding composition according to claim 1, wherein the filler is an inorganic filler that is selected from at least one of talc powder, mica powder, calcium silicate, calcium carbonate, barium sulfate, alumina (Al₂O₃) and glass fiber.

7. The eco-friendly polyester molding composition according to claim 1, wherein the glass fiber has a length between 0.5 cm and 5 cm.

8. The eco-friendly polyester molding composition according to claim 1, further comprising 20 to 70 PHR of an additive that is selected from at least one of a polymerization inhibitor, a low shrinkage agent, a tackifier, a mold release agent and a colorant.

9. A method for manufacturing a plastic board, comprising:
well mixing the eco-friendly polyester molding composition as claimed in claim 1 to form a fiber-reinforced resin material; and
molding the fiber-reinforced resin material into the plastic board at a molding temperature between 130° C. and 150° C.;
wherein the plastic board has a styrene emission rate of 45 μg/m²×hr.

10. The method according to claim 9, further comprising trimming the plastic board and applying a coating to the plastic board.
